(19) United States
(12) Patent Application Publication
(10) Pub. No.: US 2010/0128614 A1
(43) Pub. Date: May 27, 2010

(54) Resource allocation in communications system

(75) Inventors: Markku Kuusela, Lahti (FI); Petteri Lunden, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/457,453

(22) Filed: Jun. 11, 2009

(30) Foreign Application Priority Data
Nov. 21, 2008 (FI) 20086111

(51) Int. Cl. H04L 12/26; H04L 12/66

(52) U.S. Cl. 370/252; 370/352

(57) ABSTRACT

The application discloses a method for resource allocation in a communications system. The system comprises an apparatus, such as a base station, arranged to monitor the allocation of resource blocks to scheduled data packets. On the basis of the monitoring, eventual non-allocated resource blocks are detected. The apparatus is thus arranged to perform a priority calculation on scheduled user terminals. On the basis of the calculation, one or more of the scheduled user terminals are selected as priority user terminals. Next, the method comprises performing a further allocation step, wherein the non-allocated resource blocks are allocated to one or more of the priority user terminals.

### CROSS REFERENCE TO RELATED APPLICATIONS

The present application is related to, and claims the priority of, Finnish Patent Application No. 20086111, filed Nov. 21, 2008, the entirety of which is incorporated herein by reference.

### BACKGROUND

### Field

The exemplary and non-limiting embodiments of this invention relate generally to allocation of physical resource blocks in a communications system.

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

In a scheduling process, processor time is divided between processes that are to be run. Scheduling is carried out according to the priorities of the processes. A baseline packet scheduling (PS) algorithm for VoIP (voice over internet protocol) traffic in a 3GPP LTE (third generation partnership project long term evolution) system is a dynamic packet scheduling method, where each packet on a downlink shared channel is dynamically scheduled via physical downlink control channel (PDCCH) signalling. Dynamic packet scheduling is able to fully exploit time and frequency domain scheduling gains, with the cost of increased PDCCH overhead.

An issue associated with the increased PDCCH overhead for dynamic packet scheduling is that, due to a control channel limitation, a physical downlink shared channel (PDSCH) bandwidth is not fully exploited as not enough control channel (PDCCH) resources exist to schedule every physical resource block (PRB) in the bandwidth. This is especially the case with e.g. a 100% penetration of VoIP users, due to the relatively small size of a VoIP packet.

Packet bundling is a method for grouping multiple transport blocks of a user together into a single L1 (layer 1) transmission, e.g. on the basis of quality of service or destination, within the packet switch. During a bundling operation, packets experience a delay that depends on the actual implementation of the bundling and scheduling scheme. According to system level simulations, a PDSCH utilisation rate without packet bundling is approximately 40%, whereas with packet bundling, control channel limitation may be partly avoided and hence the PDSCH utilisation rate may be increased up to 70%. Nevertheless, a significant amount of PDSCH bandwidth remains unused, if a 100% penetration of VoIP traffic is assumed, and the packet scheduling algorithm used for VoIP traffic is the baseline one, i.e. dynamic PS.

One option to make use of the unused PDSCH capacity is e.g. to allocate the unused PDSCH transmission power amongst scheduled physical resource blocks (PRB). With such an approach, the transmission power per scheduled PRB may be increased, implying a reduced packet error rate (PER) for the scheduled users. This again leads to an increased VoIP capacity as PDCCH capacity consumption is reduced as fewer HARQ re-transmissions per scheduled user is needed, and therefore more users may be scheduled within the same PDCCH capacity.

However, the above arrangement may, for instance, increase interference experienced by users in the neighbouring cells operating at an overlapping bandwidth (for example, bearing in mind the average PDSCH utilization rates for dynamic PS, the average transmission power per scheduled PRB may increase up to 4 dB, if unused PDSCH transmission power is divided between the scheduled PRBs).

Another alternative solution to make use of the unused PDSCH capacity is to reduce the target PER used by link adaptation (LA), which also implies savings in PDCCH capacity consumption due to reductions in the required HARQ re-transmissions (as the reduced target PER may lead to the usage of a more conservative MCS and hence to a lowered PER of the first transmission). These savings in the PDCCH capacity consumption may not map to capacity gains, as a reduction of target PER may also imply reductions in packet bundling utilisation probability, which again may have a negative impact to the capacity.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Various aspects of the present invention comprise a method, a system, an apparatus and a software program product as defined in the independent claims. Further embodiments of the invention are disclosed in the dependent claims.

An aspect of the invention relates to a method for resource allocation in a communications system comprising an apparatus arranged to monitor the allocation of resource blocks to scheduled data packets. On the basis of the monitoring, eventual unused resource blocks can be detected. The apparatus is thus arranged to perform a priority calculation on scheduled user terminals. On the basis of the calculation, one or more of the scheduled user terminals are selected as priority user terminals. The method further comprises performing a further allocation step, wherein the unused resource blocks are allocated to one or more of the priority user terminals.

Although the various aspects, embodiments and features of the invention are recited independently, it should be appreciated that all combinations of the various aspects, embodiments and features of the invention are possible and within the scope of the present invention as claimed.

The present solution enables a more efficient utilisation of PDCCH capacity, which again leads to an improved VoIP capacity in circumstances where the VoIP capacity is control channel limited. Moreover, variations in interference experienced in the neighbouring cells may be reduced.

### BRIEF DESCRIPTION OF THE DRAWINGS

In the following, the invention will be described in greater detail by means of exemplary embodiments and with reference to the attached drawings, in which

FIG. 1 illustrates a communications system according to an exemplary embodiment of the present solution;

FIG. 2 illustrates signalling according to an exemplary embodiment of the present solution;

FIG. 3 is a flow chart illustrating functioning of an apparatus according to an exemplary embodiment of the present solution;

FIG. 4 is a block chart illustrating an apparatus according to an exemplary embodiment of the present solution.

### DETAILED DESCRIPTION

Link adaptation (LA) in wireless communications refers to the matching of modulation, coding and other signal and protocol parameters with the conditions of a radio link. It uses an algorithm that adapts an appropriate modulation and coding scheme (MCS) according to the quality of the radio channel, thus determining the bit rate and robustness of the data transmission. Link adaptation is a dynamic process, and the signal and protocol parameters may change as the radio link conditions change.

Exemplary embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout. Exemplary embodiments of the present solution will be described with reference to a cellular mobile communications system, such as an evolved UMTS terrestrial radio access network E-UTRAN. However, the solution is not meant to be restricted to these embodiments. The present solution is applicable to any apparatus, network node, user terminal, corresponding component(s), and/or to any communication system or any combination of different communication systems capable of performing dynamic packet scheduling. The communication system may be a fixed communication system or a wireless communication system or a communication system utilizing both fixed networks and wireless networks. The protocols used, the specifications of communication systems and network nodes, especially in mobile and wireless communication, develop rapidly. Such development may require extra changes to an embodiment. Therefore, all words and expressions should be interpreted broadly and they are intended to illustrate, not to restrict, the embodiment. The relevant inventive aspect is the functionality concerned, not the network element or equipment where it is executed.

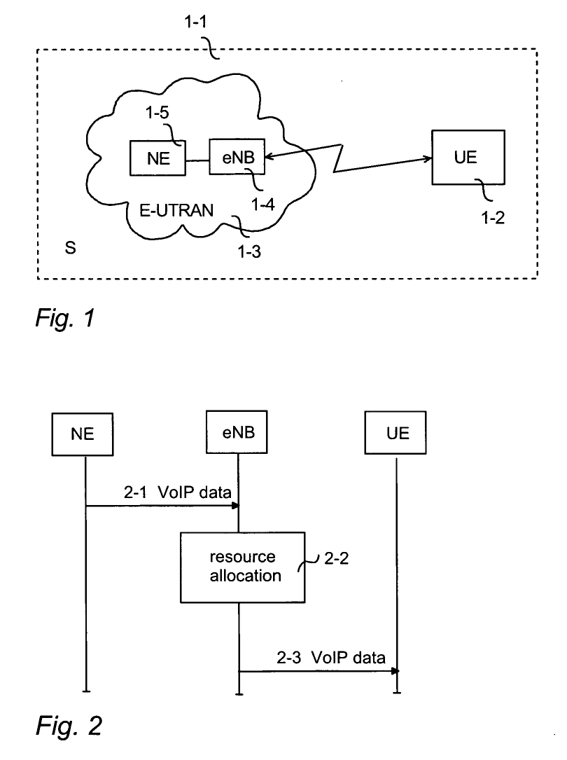

FIG. 1 provides an example of an environment where the present solution may be used. Referring to FIG. 1, a communications system (S) 1-1 comprises a user equipment (UE) 1-2 that may be e.g. a mobile or wireless user terminal, such as a mobile phone (mobile station), a personal digital assistant (PDA), a game console, a smart phone, a personal computer (PC), a laptop, a desktop computer or the like, capable of receiving PDSCH data. The system 1-1 further comprises an access network 1-3, such as an evolved UMTS terrestrial radio access network of an enhanced cellular network (E-UTRAN). Although E-UTRAN is discussed as a primary example herein, the present solution is not limited to E-UTRAN, LTE, and/or 3GPP systems. Thus, the present solution may also be applicable to other communications systems such as WiMAX (worldwide interoperability for microwave access) and/or WLAN (wireless local area network). E-UTRAN 1-3 comprises an apparatus that may include e.g. a network node or a component, such as an LTE base station (eNB, E-UTRAN node B, eNodeB) 1-4, capable of utilizing dynamic packet scheduling. E-UTRAN 1-3 further comprises a network element (NE) 1-5 which may be e.g. a radio network controller or some other radio network node capable of communicating with eNB 1-4. Here it is assumed that the user equipment (UE) 1-2 is capable of communicating with the network via the base station (eNB) 1-4 by utilizing an air interface (also referred to as a radio interface, illustrated by an arrow in FIG. 1).

FIG. 1 shows a simplified version of an evolved UMTS (universal mobile telecommunications system) terrestrial radio access network structure, which only illustrates the components that are essential to illustrate the present solution, even though those skilled in the art naturally know that a general communications system also comprises other functions and structures, which do not have to be described in more detail herein. The network node eNB 1-4 may include any network element operated by a network operator in an enhanced cellular or wireless network, such as a base station, access point, radio network controller, database, and/or a network computer or server. Although each network element UE 1-2, eNB 1-4, E-UTRAN 1-3 has been depicted as one entity, different modules and memory may be implemented in one or more physical or logical entities. A general architecture of a communication system providing session-based group communication is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for group communication are irrelevant to the actual invention. Therefore, they need not to be discussed in more detail here.

FIG. 2 illustrates signalling between network elements according to the present solution. Referring to FIG. 2, an apparatus (which may be e.g. a base station such as an LTE base station eNB) receives, in step 2-2, packet switched data 2-1 transmitted from a network element NE (such as a radio network element NE). The packet switched data may include e.g. VoIP data traffic. After the data transmitted in the message 2-1 has been received in the base station eNB in step 2-2, the base station eNB is arranged to monitor, in step 2-2, allocation of resource blocks to scheduled user terminals. On the basis of the monitoring, unused resource blocks, if any, can be detected in step 2-2. The term “unused” refers to blank (empty) resource blocks which at that moment contain no physical user data. A priority calculation is performed on scheduled user terminals UE (wherein the term “scheduled user terminals” refers to user terminals to which the scheduled data packets are directed to). The priority calculation may be performed only if unused resource blocks are detected. Another option is that it is performed even if no unused resource blocks are detected. On the basis of the priority calculation, one or more user terminals UE are selected as priority user terminals UE. In a further allocation step 2-2, the unused resource blocks (if any) are allocated to the priority user terminals UE. (Thus, as a result, some or all of the “unused” (blank) resource blocks may become “used” resource blocks carrying physical user data (e.g. VoIP data). In a message 2-3, the packet switched data is transmitted over the air interface to the user terminal UE, wherein the transmission capacity is divided (i.e. allocated) between the user terminals as defined in step 2-2.

In an exemplary embodiment, the present solution enables maximal savings to be achieved in PDCCH capacity, which again map to gains in VoIP capacity, if the system performance is control channel limited. An exemplary embodiment involves reducing the expected amount of required HARQ re-transmissions over the selected users in an OFDM sub-frame by allocating unused PRBs for users who provide the biggest savings in PDCCH capacity consumption relative to the additional costs in the resource allocation (RA) size. In order to identify users between which the unused PRBs are shared, a special user priority metric function P may be used.

For example, in order to avoid interference boosting in neighbouring cells, the present solution may make use of the unused PDSCH transmission capacity by allocating the unused PDSCH bandwidth amongst the scheduled users. As unused PRBs are cleverly allocated to the scheduled users, savings in PDCCH consumption may be achieved, which again map to VoIP capacity gains. According to an exemplary embodiment, the present solution enables allocation of unused PRBs, so that VoIP system performance is increased.

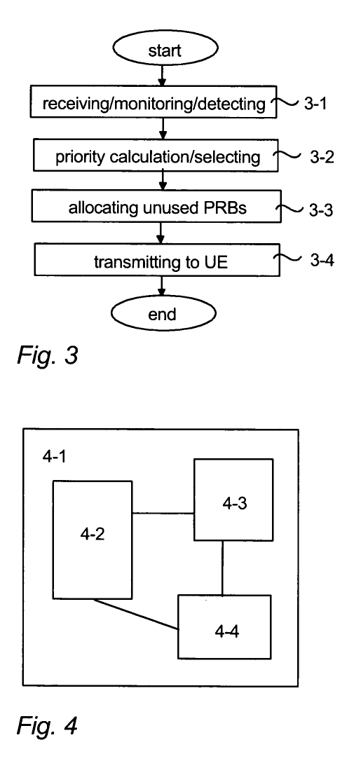

FIG. 3 is a flow chart illustrating functioning of an apparatus eNB according to an embodiment of the present solution. Referring to FIG. 3, as the process starts, the apparatus (such as an E-UTRAN base station eNB) receives, in step 3-1, packet switched data transmitted from a network element NE (such as a radio network element NE). The packet switched data may include e.g. VoIP data traffic. After the data has been received in the base station eNB in step 3-1, the base station is arranged to monitor 3-1 the allocation of the physical resource blocks PRB to scheduled user terminals. On the basis of the monitoring, unused resource blocks, if any, can be detected 3-1. In step 3-2, a priority calculation is performed on scheduled user terminals UE by utilizing a selected priority metric. For a user terminal “i”, the value of the priority metric may be defined as follows:

P(i)=S(i)/C(i),

where S and C represent user terminal specific savings and costs functions, respectively. A return value of the savings function So reflects estimated savings in PDCCH capacity consumption that are achieved if the size of the PDSCH resource allocation for the user terminal i is increased so that it allows the utilisation of MCS having an index MCS(i)-1, instead of MCS(i), in the transmission of data. Here, MCS(i) is an index of MCS that would originally be selected by a link adaptation (LA) unit if the size of resource allocation (RA) stayed unchanged. Furthermore, the cost function C( ) returns the “costs” in terms of “extra PRBs” that are required to enable the utilization of MCS having an index MCS(i)-1 (wherein MCS(i)-1 is a more robust MCS when compared to MCS(i)) in the transmission of MAC PDU without the need of L1 bit puncturation. An exemplary definition for the savings and costs functions is as follows:

S(i)=PER_reduction(i)*PDCCH_allocation_size(i)

C(i)=PRB_increase(i)

In the above, PER_reduction(i) is an estimated reduction in a packet error rate (PER) of the first transmission of a transport block, which is achieved by using a more robust MCS in the transmission (e.g. MCS(i)-1 instead of MCS(i)). That may be estimated in eNB by utilizing channel quality indicator (CQI) information. PDCCH_allocation_size(i) is the size of PDCCH allocated to the user terminal i, e.g. in terms of CCEs or REs. PRB_increase(i) is the required increase in the size of resource allocation in terms of PRBs, in order to fit MAC PDU to PDSCH without L1 bit punctuation. It may be estimated in eNB, by utilizing CQI information. On the basis of the priority calculation in step 3-2, one or more user terminals UE are selected as priority user terminals. This means that for each scheduled user terminal UE, the value of the priority metric P( ) is calculated (by using the function P(i)=S(i)/C(i)), and the selected user terminals are arranged in a descending order according to the priority metric. A list containing the user terminal indices in the descending order according to their priorities is denoted by O[ ]. The number of unused PRBs, “U”, is also determined, and i is set to zero, i.e. i=0. In a further allocation step 3-3, the unused resource blocks (if any) are allocated (e.g. by utilizing a frequency-domain packet scheduler (FDPS) located in eNB) to the priority user terminals according to an allocation algorithm. The allocation algorithm for allocating the unused resource blocks may be as follows:

Stage 1. It is checked whether C(O[i])<=U. If yes, C(O[i]) unused PRBs are allocated to a user having an index O[i], and those PRBs are marked as used PRBs; the process also sets: U=U−C(O[i]).

Stage 2. If U>0 and i<Size(O[ ]),the process sets: i=i+1, and the process returns to Stage 1. Otherwise, the process exits the allocation algorithm.

If reliable narrowband CQI information is available, the best C(O[i]) unused PRBs in terms of CQI may be allocated, in Stage 1, to the user terminal in question. Otherwise, it may be reasonable to spread the additional allocation of C(O[i]) PRBs for the user terminal in question as evenly as possible over the available bandwidth. If MCS(i)=index of the smallest MCS, P(i)=0. In step 3-4, the packet switched data is transmitted over the air interface to the user terminal UE, wherein the transmission capacity is divided (i.e. allocated) between the user terminals (UE) as defined in step 3-3. After step 3-4, the process may end. When selecting user terminals to which the extra PRBs are to be allocated, PRBs may not be allocated to a user terminal with a higher priority, if PRBs available (e.g. unused) for the terminal are not sufficient for enabling the utilization of a more robust MCS in a transmission of data on PDSCH. The allocation procedure may end at the end of the list of priority terminals, and/or when a more robust MCS cannot be provided to any user terminal during the selected TTI (transmission time interval).

On a TTI (transmission time interval) basis, by monitoring the PDCCH and PDSCH consumption, eNB is able to detect that, due to the lack of PDCCH resources, part of the PDSCH bandwidth remains unused. If this is the case, eNB may allocate the unused PRBs amongst the selected user terminals by using the method according to the present solution. For that purpose, eNB calculates the priority metric for each of the scheduled user terminals, and then follows the procedure described above. The information already existing in eNB (e.g. CQI information, and information on the size of PDCCH per scheduled user terminal) may be sufficient when calculating the priority metric; in that case, no additional information needs to be provided from UE to eNB. The present solution is thus completely transparent to the user terminals UE.

FIG. 4 illustrates an apparatus according to an exemplary embodiment the present solution. In the exemplary embodiment, the apparatus 4-1 comprises a processor 4-2 configured to generate a data signal, wherein the processor may be operably coupled to a memory module 4-3 configured to store a data signal. The processor and/or the memory module may further be operably coupled to e.g. a transmission module 4-4 configured to send a data signal, and/or a receiver module 4-4 configured to receive a data signal.

Thus, an aspect of the invention relates to a method comprising monitoring allocation of resource blocks to scheduled data packets, and, on the basis of that, detecting unused resource blocks. In the method, a priority calculation is performed on scheduled user terminals, and, on the basis of that, one or more user terminals are selected as priority user terminals, and wherein the unused resource blocks are allocated to one or more priority user terminals in a further allocation step.

A further aspect of the invention relates to an apparatus configured to monitor allocation of resource blocks to scheduled data packets, and, on the basis of that, detect unused resource blocks. The apparatus is configured to perform a priority calculation on scheduled user terminals, and, on the basis of that, select one or more user terminals as priority user terminals, wherein the apparatus is configured to allocate the unused resource blocks to one or more priority user terminals in a further allocation step.

A still further aspect of the invention relates to a software program product embodied in computer-readable medium. The computer program product comprising program instructions, wherein execution of said program instructions causes an apparatus to perform following tasks: monitoring allocation of resource blocks to scheduled data packets; detecting unused resource blocks on the basis of the monitoring; performing a priority calculation on scheduled user terminals; selecting, on the basis of the calculating, one or more user terminals as priority user terminals; and allocating the unused resource blocks to one or more priority user terminals in a further allocation step.

In an embodiment, the priority calculation comprises calculating, for a selected user terminal, control channel capacity savings achievable in the further allocation step, in relation to the number of resource blocks required in the further allocation step.

In a further embodiment, the capacity savings achievable for the selected user terminal in the further allocation step are proportional to a reduction achievable in a packet error rate if a more robust modulation and coding scheme is utilized.

In a yet further embodiment, the capacity savings achievable for the selected user terminal in the further allocation step are proportional to a size of a control channel to be allocated to the selected user terminal.

In a yet further embodiment, it is checked whether the number of resource blocks required by a selected priority user terminal in the further allocation step is lower than or equal to the number of unused resource blocks. If the number of resource blocks required by the selected priority user terminal in the further allocation step is lower than or equal to the number of unused resource blocks, the required resource blocks are allocated to the selected priority user terminal.

In a yet further embodiment, the resource blocks allocated to the selected priority user terminal are defined as used resource blocks, instead of unused resource blocks, in order to achieve a modified number of unused resource blocks. It is checked whether the number of resource blocks required by a further user terminal in the further allocation step is lower than or equal to the modified number of unused resource blocks. If the number of resource blocks required by the further user terminal in the further allocation step is lower than or equal to the modified number of unused resource blocks, the required resource blocks are allocated to the further user terminal.

In a yet further embodiment, the selected priority user terminal is a user terminal having the highest priority on the basis of the priority calculation.

In a yet further embodiment, the further user terminal is a user terminal having the second highest priority on the basis of the priority calculation.

In a yet further embodiment, the required resource blocks are allocated to a user terminal having, on the basis of the priority calculation, the highest priority among user terminals to which the number of unused resource blocks is sufficient for enabling utilization of a more robust modulation and coding scheme.

In a yet further embodiment, the required resource blocks are allocated to a user terminal having, on the basis of the priority calculation, the highest priority among user terminals to which the modified number of unused resource blocks is sufficient for enabling utilization of a more robust modulation and coding scheme.

In a yet further embodiment, the allocation of PRBs is enhanced without reducing target PER.

In a yet further embodiment, the allocation of PRBs is enhanced without reducing packet bundling.

In a yet further embodiment, it is detected that due to a lack of PDCCH resources, some PDSCH resources are to remain unused.

In a yet further embodiment, dynamic packet scheduling is enhanced e.g. in a VoIP system.

In a yet further embodiment, the apparatus comprises e.g a base station.

In a yet further embodiment, the apparatus comprises e.g. a frequency-domain packet scheduler FDPS.

In a yet further embodiment, user terminals on the priority list are handled according to their priorities (one-by-one), and unused PRBs may be allocated to the user terminal in question only once, i.e. after allocating some unused PRBs, e.g. for the highest priority user terminal, it may not possible to give during the allocation process any additional PRBs to the user terminal. Additional resources may be given for a user terminal only once, i.e. it may not be possible to allocate unused PRBs twice for the same user terminal, which means that e.g. MCS-2 may be used instead of original MCS (e.g. MCS-2 may be used instead of MCS-1). U

In a yet further embodiment, it is possible to recompute the priority for a user terminal after a first reallocation of PRBs, and if the priority is high enough, to allow a further reallocation of PRBs to the same user terminal. For example, if the target PER of UE is relatively high (e.g. >20%), it may be beneficial to go e.g. from MCS-1 to MCS-2.

In a yet further embodiment, user terminals are handled in the order of their priorities, and may be skipped, if the required resources for enabling the utilisation of a more robust MCS are higher than the available resources.

The following exemplary simulation assumptions may be used:

Macro cell scenarios case 1, case 3 (3GPP TR 25.814)

PDP: typical urban with 20 taps

Bandwidth: 5 MHz

Codec: AMR 12,2 kbps

VoIP optimized scheduler where each packet is dynamically scheduled with associated PDCCH

Packet bundling (up to 2 packets/TTI/user)

10 control channel elements available for DL scheduling grants

Velocity 3 km/h

CQI resolution: narrowband CQI˜1 PRB or wideband CQI

1×2 MRC

Target PER 20%

Tx power per PRB=

total_eNB_tx_power/total_number_of_PRBs, i.e. transmission power per scheduled PRBs does not depend on the number of scheduled PRBs.

TABLE 1

| | | Relative gain [%] in |
|---|---|---|
| | Capacity | capacity over |
| Scenario | reference/invention | the reference |
| Case 1, narrowband CQI | 309/333 | 7% |
| Case 1, wideband CQI | 274/300 | 9% |
| Case 3, narrowband CQI | 226/270 | 20% |

As can be seen in Table 1, the greatest benefit is realized in Example 3, where the amount of weak users relying on HARQ (hybrid automatic repeat request) re-transmissions is clearly higher than in Example 1, implying that more PDCCH resources are consumed to serve re-transmitting users. The PER value of the weak users is reduced whilst the packet bundling efficiency for the good users is maintained. Thus, according to this example, significant gains in capacity may be provided over a case where unused PDSCH is not exploited and transmission power allocated per scheduled PRB is restricted to P_tot/Tot_No_PRBs, where P_tot is the total transmission power of PDSCH and Tot_No_PRBs is the total number of PRBs.

It should be noted that, in addition to VoIP, the present solution is also applicable to any other traffic type, whose performance suffers from control channel limitation. Examples of such traffic types include e.g. streaming and gaming.

It should be noted that, in addition to/instead of allocating unused downlink resource blocks, the present solution may also be applicable to allocating unused uplink resource blocks.

The items and steps shown in the figures are simplified and only aim at describing the idea of the present solution. Other items may be used and/or other functions carried out between the steps. The items serve only as examples and they may contain only some of the information mentioned above. The items may also include other information, and the titles may deviate from those given above. The order of the items and/or steps may deviate from the given ones. Instead of or in addition to a base station, radio network controller, and/or user terminal, the above-described operations may be performed in any other element of a communications system.

In addition to prior art means, a system or system network nodes that implement the functionality of the present solution comprise means for allocating radio network resources as described above. Existing network nodes and user terminals comprise processors and memory that can be utilized in the operations of the present solution. Any changes needed in implementing the present solution may be carried out using supplements or updates of software routines and/or routines included in application-specific integrated circuits (ASIC) and/or programmable circuits, such as EPLDs (electrically programmable logic device) or FPGAs (field programmable gate array).

It will be obvious to a person skilled in the art that, as technology advances, the inventive concept can be implemented in various ways. The invention and its embodiments are not limited to the examples described above but may vary within the scope of the claims.

List of Abbreviations

PDCCH physical downlink control channel (control channel to be used to transmit e.g. DL/UL scheduling related information to the UEs)

PDSCH downlink shared channel (transport channel for high data rate traffic)

PDSCH physical downlink shared channel (physical channel to carry PDSCH)

PRB physical resource block (consists of 12 consecutive sub-carriers—minimum allocation unit in frequency domain)

PER packet error rate

HARQ hybrid automatic repeat request

RA resource allocation

MCS modulation and coding scheme (link adaptation unit selects for each scheduled user an appropriate MCS on the basis of the channel conditions of the scheduled user—the technique is needed to adapt transmission to the channel conditions at the receiver; this technique may also be referred to as adaptive modulation and coding (AMC))

LA link adaptation (selects the appropriate MCS for each scheduled user)

MAC medium access control

PDU packet data unit

MAC PDU may also be called a transport block TB which is delivered from MAC to physical layer (L1)

eNB LTE base station

CCE control channel element (one PDCCH consists of multiple CCEs such that one CCE is the minimum size for PDCCH that is applicable to good users only; for the users in weaker channel conditions 2, 4 or at most 8, CCEs can be aggregated together. Hence possible PDCCH sizes are 1, 2, 4 or 8 CCEs)

RE resource element (minimum resource unit in LTE, denotes a sub-carrier symbol within an OFDM symbol. One CCE consists of a set of REs)

TB transport block

TTI transmission time interval

UE user equipment

1. A method, comprising:
monitoring allocation of the resource blocks to scheduled data packets in a communications system;
based on said monitoring, detecting unused resource blocks;
performing a priority calculation on scheduled user terminals;
selecting, based on said calculation, one or more user terminals as priority user terminals; and
performing a further allocation, wherein the unused resource blocks are allocated to one or more priority user terminals.

2. A method as claimed in claim 1, wherein the priority calculation comprises calculating, for a selected user terminal, control channel capacity savings achievable in the further allocation, in relation to the number of resource blocks required in the further allocation.

3. A method as claimed in claim 2, wherein the capacity savings achievable for the selected user terminal in the further allocation are proportional to a reduction achievable in a packet error rate if a more robust modulation and coding scheme is utilized.

4. A method as claimed in claim 2, wherein the capacity savings achievable for the selected user terminal in the further allocation are proportional to a size of a control channel to be allocated to the selected user terminal.

5. A method as claimed in claim 1, further comprising:
checking whether the number of resource blocks required by a selected priority user terminal in the further allocation is lower than or equal to the number of unused resource blocks, wherein if the number of resource blocks required by the selected priority user terminal in the further allocation is lower than or equal to the number of unused resource blocks; and
allocating the required resource blocks to the selected priority user terminal.

6. A method as claimed in claim 5, further comprising:
defining the resource blocks allocated to the selected priority user terminal as used resource blocks, instead of unused resource blocks, in order to achieve a modified number of unused resource blocks;
checking whether the number of resource blocks required by a further user terminal in the further allocation is lower than or equal to the modified number of unused resource blocks, wherein if the number of resource blocks required by the further user terminal in the further allocation is lower than or equal to the modified number of unused resource blocks; and
allocating the required resource blocks to the further user terminal.

7. A method as claimed in claim 5, wherein the selected priority user terminal is a user terminal having the highest priority based on the priority calculation.

8. A method as claimed in claim 6, wherein the further user terminal is a user terminal having the second highest priority based on the priority calculation.

9. A method as claimed in claim 5, further comprising:
allocating the required resource blocks to a user terminal having, based on the priority calculation, the highest priority among user terminals to which the number of unused resource blocks is sufficient for enabling utilization of a more robust modulation and coding scheme.

10. A method as claimed in claim 6, further comprising:
allocating the required resource blocks to a user terminal having, based on the priority calculation, the highest priority among user terminals to which the modified number of unused resource blocks is sufficient for enabling utilization of a more robust modulation and coding scheme.

11. A method as claimed in claim 1, further comprising:
enhancing the allocation of physical resource blocks PRB without reducing packet bundling probability for the user terminal to which unused PRBs are allocated.

12. A method as claimed in claim 1, further comprising:
detecting that due to a lack of physical downlink control channel PDCCH resources, some physical downlink shared channel PDSCH resources are to remain unused.

13. A method as claimed in claim 1, further comprising:
enhancing dynamic packet scheduling in a voice over Internet protocol VoIP system.

14. An apparatus, comprising:
a processor configured to
monitor allocation of resource blocks to scheduled data packets;
based on said monitoring, detect unused resource blocks;
perform a priority calculation on scheduled user terminals;
select, based on said calculation, one or more user terminals as priority user terminals; and
perform a further allocation, wherein said unused resource blocks are allocated to the priority user terminals.

15. An apparatus as claimed in claim 14, wherein the priority calculation comprises calculating, for a selected user terminal, control channel capacity savings achievable in the further allocation, in relation to the number of resource blocks required in the further allocation.

16. An apparatus as claimed in claim 15, wherein the capacity savings achievable for the selected user terminal in the further allocation are proportional to a reduction achievable in a packet error rate if a more robust modulation and coding scheme is utilized.

17. An apparatus as claimed in claim 15, wherein the capacity savings achievable for the selected user terminal in the further allocation are proportional to a size of a control channel to be allocated to the selected user terminal.

18. An apparatus as claimed in claim 14, wherein the processor is further configured to
check whether the number of resource blocks required by a selected priority user terminal in the further allocation is lower than or equal to the number of unused resource blocks, wherein if the number of resource blocks required by the selected priority user terminal in the further allocation is lower than or equal to the number of unused resource blocks; and
allocate the required resource blocks to the selected priority user terminal.

19. An apparatus as claimed in claim 18, wherein the processor is further configured to
define the resource blocks allocated to the selected priority user terminal as used resource blocks, instead of unused resource blocks, in order to achieve a modified number of unused resource blocks;
check whether the number of resource blocks required by a further user terminal in the further allocation is lower than or equal to the modified number of unused resource blocks, wherein if the number of resource blocks required by a further terminal in the further allocation is lower than or equal to the modified number of unused resource blocks; and
allocate the required resource blocks to the further user terminal.

20. An apparatus as claimed in claim 18, wherein the processor is further configured to:
define that the selected priority user terminal is a user terminal having the highest priority based on the priority calculation.

21. An apparatus as claimed in claim 19, wherein the processor is further configured to:
define that the further user terminal is a user terminal having the second highest priority based on the priority calculation.

22. An apparatus as claimed in claim 14, wherein the processor is further configured to
enhance the allocation of physical resource blocks PRB without reducing packet bundling probability for the user terminal to which unused PRBs are allocated.

23. An apparatus as claimed in claim 14, wherein the processor is further configured to
detect unused physical downlink shared channel PDSCH resources due to a lack of physical downlink control channel PDCCH resources.

24. An apparatus as claimed in claim 14, wherein the apparatus comprises a base station.

25. An apparatus as claimed in claim 14, wherein the apparatus comprises a frequency-domain packet scheduler.

26. An apparatus, comprising:
monitoring means for monitoring the allocation of the resource blocks to the scheduled data packets;
detecting means for detecting unused resource blocks based on said monitoring;
performing means for performing a priority calculation on scheduled user terminals;
selecting means for selecting, based on said calculation, one or more user terminals as priority user terminals; and
performing means for performing a further allocation, wherein said unused resource blocks are allocated to one or more priority user terminals.

27. An apparatus as claimed in claim 28, wherein it comprises means for calculating, for a selected user terminal, control channel capacity savings achievable in the further allocation, in relation to the number of resource blocks required in the further allocation.

28. A computer-readable storage medium encoded with instructions configured to cause a computer processor to perform a process, the process comprising:
monitoring allocation of resource blocks to scheduled data packets;
based on said monitoring, detecting unused resource blocks;
performing a priority calculation on scheduled user terminals;
selecting, based on said calculation, one or more user terminals as priority user terminals; and
performing a further allocation, wherein the unused resource blocks are allocated to one or more priority user terminals.

29. A computer-readable storage medium as claimed in claim 28, program code means being adapted to perform a task of calculating, for a selected user terminal, control channel capacity savings achievable in the further allocation, in relation to the number of resource blocks required in the further allocation.
